(19) United States
(12) Patent Application Publication
(10) Pub. No.: US 2016/0201622 A1
(43) Pub. Date: Jul. 14, 2016

(54) FUEL SUPPLY SYSTEM

(71) Applicant: HYDAC FILTERTECHNIK GMBH, Sulzbach/Saar (DE)

(72) Inventors: Micha KREIBIG, Rehlingen-Siersburg (DE); Richard EBERLE, Ornesheim (DE); Thomas SCHOLL, Saarlouis (DE)

(21) Appl. No.: 14/912,422

(22) PCT Filed: Aug. 18, 2014
(86) PCT No.: PCT/EP2014/002265

§ 371 Date: Feb. 17, 2016

(30) Foreign Application Priority Data
Aug. 22, 2013 (DE) 10 2013 014 291.1

(51) Int. Cl. F02M 37/04; F02M 37/22; F02M 37/00

(52) U.S. Cl. CPC F02M 37/04; F02M 37/0023; F02M 37/0052; F02M 37/221

(57) ABSTRACT

The invention relates to a fuel supply system consisting of at least one storage tank, especially a fuel tank (10), an engine (12), preferably in the form of a common rail diesel engine, that can be operated with the fuel, an engine-pump unit (32) and a pre-supply pump (16) for supplying the engine (12) with fuel from the storage tank (10), and a filter device (28) arranged between the storage tank (10) and the engine (12). The pump (34) of the engine-pump unit (32) is mounted down-stream of the filter device (28) when seen in the flow direction of the fuel and is preferably fluidically connected to the clean side of the filter device.

The invention relates to a fuel supply system, consisting of at least
one storage tank, in particular, a fuel tank,
an engine capable of being powered with the fuel, preferably in the form of a common rail diesel engine
a engine pump unit and a pre-supply pump for supplying the engine with fuel from the storage tank, and
a filter device disposed between the storage tank and the engine.

The invention also relates to a preferably modularly constructed supply system, applicable in particular for fluidic feed systems such as the aforementioned fuel supply system.

In modern engines such as diesel engines having common rail fuel injection, referred to technically as “accumulator fuel injection”, and which regularly concerns fuel injection systems for internal combustion engines, a high pressure pump is provided as a pre-supply pump, which raises the fuel from a storage tank to a very high pressure level. The pressurized fuel fills a pipe system of a fuel supply circuit, which is constantly under this pressure during engine operation. To be able to take account of the modern demands on such a common rail fuel injection system, the differential pressure in the suction line upstream of the pre-supply pump leading to the storage tank or fuel tank is increasingly limited. Thus, from today's perspective, the pre-supply pumps of several engine manufacturers are able to generate a maximum negative intake pressure of 150 mbar, which poses two significant disadvantages for the users of such engines. On the one hand, a pre-filtration stage, which is regularly disposed between the fuel tank and the pre-supply pump, exhibits a certain differential pressure, due to structural conditions, so that with respect to the maximum negative intake pressure of 150 mbar only very little useable clearance remains and, on the other hand, the installation flexibility for the required components of the fuel supply system is restricted, in particular, for obtaining short pipe lengths in order not to degrade the values of the desired negative intake pressure still further.

To address such disadvantages, it is provided in modern fuel supply systems to connect an additional, preferably electrically powered motor pump unit in the suction line upstream of the pre-supply pump between the fuel storage tank and the filter device, in order in this way to be able to ensure the desired negative intake pressure of 150 mbar.

However, even this modern supply solution has its disadvantages, in particular, the pump used in this way must permanently feed, even if the fuel system has not yet even reached the limiting 150 mbar of maximum suction pressure of the pre-supply pump, and in addition, the fuel pump itself, when defective or is simply not provided with power, generates a differential pressure which may be significantly greater than the required 150 mbar.

That said, the object of the invention is to create a fuel supply system in a cost-efficient and functionally reliable manner, in addition to a preferably modularly constructed supply system for such fuel supply systems, which help to avoid the disadvantages described above.

Such an object is achieved by a fuel supply system having the features of claim 1 and a supply system having the features of claim 8.

Because, according to the characterizing portion of claim 1, the pump of the motor pump unit is disposed downstream from the filter device, as viewed in the flow direction of the fuel, preferably fluidically connected to the clean side thereof, and a further design of the solution according to the invention, the pump of the motor pump unit is particularly preferably connected in a branch flow to the main flow between the filter device and the pre-supply pump in the fuel circulation system, it is ensured in a cost-efficient and functionally reliable design in any case that the maximum negative intake pressure of 150 mbar prescribed by the engine manufacturers for the respective pre-supply pump can be reliably generated. The hydraulic pump, functioning preferably as a suction pump or vacuum pump of the motor pump unit, ensures that the desired maximum negative intake pressure of 150 mbar is achieved during operation, even in the case of visibly accumulating particulate contamination on the filtering components of the filter device. In this case, it is largely irrelevant where, in terms of structure, the individual components of the fuel supply system are positioned relative to one another, which is a factor in terms of the length of the aforementioned intake line to be used; in any case, the desired negative intake pressure is maintained.

For a person of average skill in the art in the area of such fuel supply systems, it is surprising to him to obtain such improved results when establishing the prescribed negative intake pressure for the pre-supply pump that supplies the engine with fuel, as a result of a structurally relatively simple measure, in which he places the already installed motor pump unit on the clean side of the filter device and preferably in the branch flow thereof.

In addition, the object according to the invention is achieved by a supply system according to the feature arrangement of claim 8. This type of preferably modularly constructed supply system consists of at least the aforementioned filter device, on the clean side of which, preferably in the branch flow thereof, the pump of the motor pump unit is fluidically connected. The supply system, constructed in the form of a module with its individual fluid connection points, may thus be directly inserted in the aforementioned fluidic feed systems or, designed as a retrofit kit, may be subsequently integrated on site in already existing feed systems.

On the whole, a differential pressure-optimized fuel supply system is implemented by the hydraulic pump of the motor pump unit operating in the branch flow. In addition, the preferably provided water separation is not adversely affected with respect to the filter device as a result of the downstream motor pump unit. In addition, a service life for the motor pump unit is optimized, since the latter operates specifically in accordance with the standard filter device, which is disposed between the fuel storage tank and the motor pump unit, so that in this way the particulate contamination of the hydraulic pump of the motor pump unit may be prevented through the filter device.

Even in the case of defective motor pump units, the pressure difference of this type of pre-filter system is not adversely affected. Moreover, it is possible, when needed, to selectively switch on or switch off the motor pump unit and a functionally reliable operation in terms of the fuel supply of the engine is still achieved, even if the motor pump unit fails, which is not the case in known systems, in which the motor pump unit is disposed upstream of the pre-filter system. If the motor pump unit is defective in this regard, then the entire fuel supply system does not function.

Additional advantageous configurations of features of the object according to the invention are the subject matter of the dependent claims. The specified negative intake pressure of 150 mbar is merely exemplary; it is of course possible to also reliably control other pressure values with the solution to the object according to the invention.

The solution according to the invention is explained in greater detail below based on various exemplary embodiments according to the drawings. In the drawings, in the form of hydraulic circuit diagrams with the conventional symbols

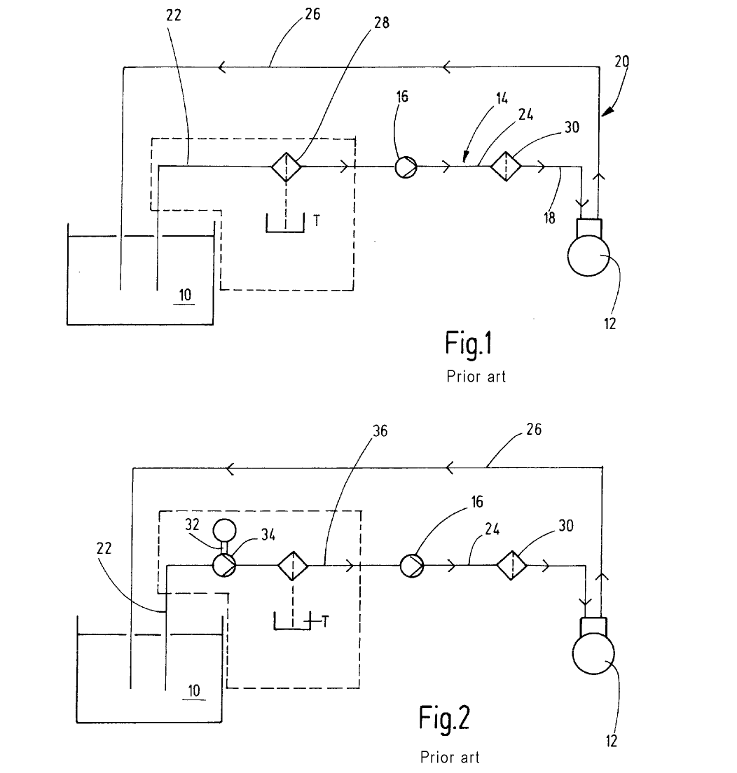

FIGS. 1 and 2 show prior art solutions;

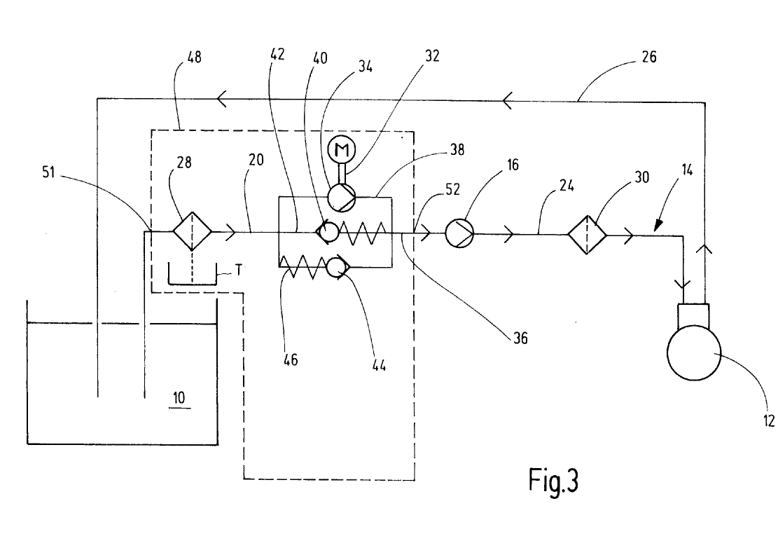

FIG. 3 shows an embodiment of the fuel supply system according to the invention, and

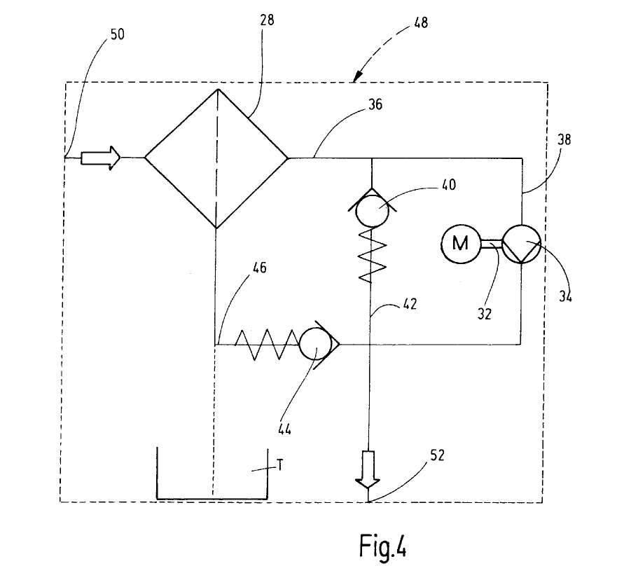

FIG. 4 shows a supply system, as it is used for a fuel supply system according to FIG. 3.

FIG. 1 shows a standard fuel supply system as it is shown by the prior art. This fuel supply system has a storage tank, in particular, a fuel tank 10, as well as an engine 12 capable of being powered with the fuel; in the present case in the form of an internal combustion engine having a common rail fuel injection system 14 known per se. A pre-supply pump 16, which may be designed as a high pressure suction pump, serves to supply the engine 12 with fuel from the storage tank 10. The fuel-carrying line 18 as part of the fuel circulation system 20 includes in sections a suction line 22, which runs between the fuel tank 10 and the pre-supply pump 16, as well as a pressure line 24 between the pre-supply pump 16 and the engine 12. In addition, the fuel circulation system 20 includes a so-called recirculation line 26 which conveys media from the engine 12 back to the fuel tank or storage tank 10.

A filter device is also connected in the fuel circulation system 20, consisting of a pre-filter 28 between the fuel tank 10 and the pre-supply pump 16, as well as a main filter 30 connected downstream from the pre-supply pump 16 and the clean side thereof leading to the diesel engine 12.

Reference numerals used in the subsequent figures that are the same as those in FIG. 1 also relate to the same components, and the statements made with regard to the latter also apply accordingly to the following embodiments.

Currently, such standard fuel systems according to FIG. 1 require the differential pressure to be limited in the suction line 22 upstream of the pre-supply pump 16 of the fuel system. The pre-supply pumps 16 of several engine manufacturers are able to generate at most a negative intake pressure of 150 mbar. For users of such engines, this has two significant disadvantages:
1. In new condition, the pre-filtration stage 28, in the case of a structurally-dictated differential pressure of, for example, 50 mbar, is still only able to build up a differential pressure increase of 100 mbar due to contamination loads, before the pre-supply pump 16, designed as a suction pump, ceases to draw.
2. The flexibility with regard to the positioning of the fuel tank 10 and the pre-supply pump 16, as well as the pre-filter stage 28, is severely restricted. The geodetic pressure between the tank 10 and the pre-supply pump 16 and the pressure loss due to the pipe system of the components, including in particular, the suction line 22 and pressure line 24, have a strong influence on the design of the machines as a result of the limited differential pressure, wherein it is frequently necessary to provide that, in terms of location, the fuel tank 10 is positioned below the pre-supply pump 16.

This is further complicated by the fact that the negative influences described above may compete with one another.

One example: If the positioning of the components alone has exhausted a large part of the available intake pressure, then the pre-filtration stage in the form of pre-filter 28 must already be replaced after a short period of use, with the result that the maintenance intervals become relatively short.

To address these disadvantages, it is currently the prior art, according to the solution of FIG. 2, to integrate an electrically-powered motor pump unit 32 in the pre-filter unit 28 upstream of the pre-supply pump 26, in order to significantly increase the flexibility in both cases (filtration and positioning of the components relative to one another). By including the hydraulic pump of the motor pump unit 32, designed as a suction pump 34, the previously described suction line 22 is shortened and the pressure line 24 is lengthened, the fuel pressure downstream from the pre-supply pump 16 then being greater than in the middle line section 36, into which the suction pump 34 on the outlet side feeds with increased pressure and into which the pre-supply pump 16 opens on the suction side.

The hydraulic pump 34 of the motor pump unit 32 thus used must permanently feed, even if the fuel system has not yet reached the limiting 150 mbar maximum suction pressure of the pre-supply pump 16. In addition, the fuel pump 34 generates a differential pressure, which may be significantly above the required 150 mbar, even in the event of a defect or when it is simply not supplied with adequate power. Because the pump 34 is connected upstream of the pre-filter 28, exclusively non-filtered fuel from the storage tank 19 flows through it, such that it is subject to a corresponding particulate contamination from the storage tank 10, which reduces the service life of the pump 34. If a water separator is integrated in a separate tank T in the pre-filter stage 28, the proportion of water to be separated by the pump unit 34 is changed in such a way that the water separation takes place only at a low quality level. This disadvantageous change is related to a reduction in the size of the water droplets to be separated since, instead of on the suction side, a water separation now takes place on the pressure side, and small water droplets are consistently more difficult to separate from the fuel than enlarged water droplets regularly formed by coalescing at the pre-filter unit 28.

With reference to the prior art cited above, the idea according to the invention begins at this point, also with integrating the motor pump unit 32 in the filter system, but this time downstream from the pre-filter stage 28 and preferably with a fluidic interconnection in the branch flow 38. As the solution according to FIG. 3 further shows, the pre-supply pump 16 will be able to independently draw fuel from the fuel tank 10 without using the motor pump unit 32. For this purpose, no flow-through of any additional differential pressure-generating component is required, other than a minimal spring-supported check valve 40 disposed in the main flow 42, as compared to the system shown in FIG. 1 and in contrast to the system depicted in FIG. 2. It is only when the motor pump unit 32 is energized by energizing the electric motor M, and therefore is switched on, that the check valve 40 is closed and the motor pump unit 32, using its suction pump 34, draws clean fuel directly via the filter stage in the form of the pre-filter 28, and is thus able to supply the pre-supply pump 16 with adequate fuel.

The spring-loaded check valve 44 shown in FIG. 3 is used merely for resetting, once a maximum excess pressure of the motor pump unit 32 is reached, the value of which is regularly specified depending on the customer. If, as a result of structural conditions such as, for example, the engine 12 being positioned far away from and/or higher than the fuel tank, with the result that the initial pressure loss may be greater than 150 mbar, a permanent operation of the motor pump unit 32 is necessary, this being readily possible as per the depiction according to FIG. 3. In the case of defective motor pump unit 32, no additional pressure loss is generated, since the motor pump unit 32 operates in the branch flow 38 and the pre-supply pump 16 is still supplied in the main flow 42 when the check valve 40 is opened. The check valve 42 disposed in the additional branch flow 46 accordingly remains in the closed position depicted in FIG. 3.

Since, in addition, the motor pump unit 32 is always supplied exclusively with fuel cleaned by the pre-filter 28 in the corresponding purity class, the service life of the hydraulic pump 34 of the unit 32 in question is increased significantly, in contrast to the solution according to FIG. 2. The water separation by the pre-filter 28, if provided, is also improved, since the water separation takes place on the suction side of the suction pump 34, which results in an enlarged droplet surface which, based on experience, can be more readily separated than small droplet surfaces.

The solution according to FIG. 4 relates to a supply system constructed in the form of a module 48. This type of module 48 can be readily integrated in a fuel supply system, as is exemplified in FIG. 3, and already existing fuel supply systems, in particular according to the embodiment of FIG. 1, may be retrofitted later with such a module 48. For both of these cases, the module 48 includes a connection point 50 on its fluid inlet side, via which the module 48 can be connected to the suction line 22. In addition, the module 48 includes an additional fluid connection point 52 on its outlet side, with which the module 48 can be connected to the suction side of the pre-supply pump 16. Otherwise, the interconnection of the motor pump unit 32 in the branch flow 38 is as described above, and the check valves 40 and 44 are connected in the main flow 42 and in the additional branch flow 46 in the middle line segment 36, which runs between pre-filter 28 and pre-supply pump 16 in the depiction according to FIG. 3. Furthermore, in the depiction according to FIG. 4, just as in the solution according to FIG. 3, the opening direction of the spring-loaded check valve 40 is oriented in the direction toward the pre-supply pump 16 and the additional check valve 44 is held, spring-loaded, in its closed position in the opposite direction.

Because of the respective branch flow configuration of the motor pump unit 32, it is possible to design the fuel system in a differential pressure-optimized way, and the water separation is not adversely affected; furthermore, the service life of the suction pumps 34 is prolonged, since the particulate contamination in the fuel can be reliably absorbed by the pre-filter unit 28 connected upstream thereof. If the motor pump unit 32 is intentionally or unintentionally non-operational, cleaned fuel still reaches the pre-supply pump 16 via the pre-filter 28 and the check valve 40 in the main flow 42. A complete failure of the fuel supply device according to the invention is thus reliably avoided.

1. A fuel supply system consisting of at least
one storage tank, in particular, a fuel tank (10),
an engine (12) capable of being powered with the fuel, preferably in the form of a diesel engine in common-rail technology,
a motor pump unit (32) and a pre-supply pump (16) for supplying the engine (12) with fuel from the storage tank (10), and
a filter device (28) disposed between the storage tank (10) and the engine (12),
characterized in that the pump (34) of the motor pump unit (32) follows the filter device (28) as viewed in the flow direction of the fuel, preferably fluidically connected to the clean side thereof.

2. The fuel supply system according to claim 1, characterized in that the pump (34) of the motor pump unit (32) is connected in the branch flow (38) to the main flow (42) between the filter device (28) and the pre-supply pump (16) in the fuel circulation system (20).

3. The fuel supply system according to claim 2, characterized in that a preferably spring-loaded check valve (40) is connected in the main flow (42), which opens in the direction toward the pre-supply pump (16).

4. The fuel supply system according to claim 1, characterized in that an additional, preferably spring-loaded, check valve (44) is connected in an additional branch flow (46) to the branch flow (38) and to the main flow (42), the opening direction of which is opposite the opening direction of the first check valve (40).

5. The fuel supply system according to claim 1, characterized in that the filter device includes a pre-filter (28), which is connected between the storage tank (10) and the pump (34) of the motor pump unit (32), which, in addition to retaining particulate contamination in the fuel, serves to separate water from the fuel.

6. The fuel supply system according to claim 1, characterized in that the filter device includes a main filter (30), which is connected in the fuel supply between the pre-supply pump (16) and the engine (12).

7. The fuel supply system according to claim 1, characterized in that the engine (12) is connected to a recirculation line (26), which establishes a media-carrying connection between the engine (12) and the storage tank (10).

8. A supply system, in particular for fluidic feed systems, such as fuel supply systems, according to claim 1, composed of at least one filter device (28), on the clean side of which, preferably in the branch flow (38), the pump (34) of a motor pump unit (32) is fluidically connected.

9. The supply system according to claim 8, characterized in that it is constructed in the form of a module (48) with its fluid connection points (50, 52) inserted in fluidic feed systems, or in the form of a modularly constructed retrofit kit with its fluid connection points (50, 52), which may be subsequently integrated in already existing feed systems.

10. The supply system according to claim 8, characterized in that check valves (40, 44) opening in opposite directions, which are held in the direction of their respective closed position preferably by means of a spring force, are connected to the pump (34) of the motor pump unit (32) in a main flow (42) and in an additional branch flow (46) to the main flow (42) and to the first branch flow (38).
